(19) United States
(12) Patent Application Publication
(10) Pub. No.: US 2011/0255300 A1
(43) Pub. Date: Oct. 20, 2011

(54) OPTICAL DISPLAY

(75) Inventors: Neal Anthony Porter, Frankston South (AU); Zenja Solaja, Maribyrong (AU); Christian James Salmon, Maidstone (AU)

(73) Assignee: Aristocrat Technologies Australia Pty Limited, North Ryde (AU)

(21) Appl. No.: 13/169,957

(22) Filed: Jun. 27, 2011

Related U.S. Application Data
(63) Continuation of application No. 12/266,188, filed on Nov. 6, 2008, now abandoned.

(30) Foreign Application Priority Data
Nov. 7, 2007 (AU) 2007906121

(51) Int. Cl. G02B 6/04; G02B 5/02; F21V 8/00

(52) U.S. Cl. 362/554; 362/559; 362/558

(57) ABSTRACT

Certain embodiments may be set to reside in an optical display. The optical display includes a plurality of strands arranged in spaced apart relationship. Each strand has a plurality of waveguides, and each waveguide has an output at a different position along the length of the respective strand. Each waveguide has an input end. The optical display also includes a light driver for supplying light to the input end of each waveguide so light can propagate along the waveguide and exit at the outputs.

### CROSS-REFERENCE TO RELATED APPLICATIONS

The present application claims the benefit of priority as a continuation to co-pending U.S. patent application Ser. No. 12/266,188, filed on Nov. 6, 2008, entitled “AN OPTICAL DISPLAY”, and also claims the benefit of priority to Australian Provisional Patent Application No. 2007906121, filed on Nov. 7, 2007, entitled “AN OPTICAL DISPLAY”, each of which is herein incorporated by reference in its entirety.

### FIELD OF THE INVENTION

This invention relates to an optical display and in particular to a display in the form of a curtain to provide an illuminated display containing a static or moving visual imagery for both decorative and informative purposes.

### BACKGROUND OF THE INVENTION

There are numerous traditional formats for providing illuminated panels in the form of curtains which use optic fibres. Typically, light is conducted along a fibre to a fibre end and the ends of the fibre are arranged so that a display is provided by light leaving the ends of the fibres.

In other arrangements, an optical fibre can be laid along a path so that when light is conducted along the fibre, the fibre effectively “glows” to provide a display.

The conventional systems do not provide great flexibility in the nature of the display which can be provided.

### SUMMARY OF THE INVENTION

Certain embodiments of the present invention may be set to reside in an optical display including:
a plurality of strands arranged in spaced apart relationship;
each strand having a plurality of waveguides with each waveguide having an output at a different position along the length of the respective strand;
each waveguide having an input end; and
a light driver for supplying light to the input end of each waveguide so light can propagate along the waveguide and exit at the outputs.

Thus, according to this aspect of the invention, the light which exits at the outputs provides a display. Because each strand has a number of outputs along the length of each strand and the strands are in side-by-side relationship, a grid format is produced so the display can be formed by the nature of the light which is provided to each respective input end and travels to the respective output end of the waveguides. The light driver can provide a static light input or a moving light input so that the display caused by light leaving the output can be a static display or a moving display. Therefore, considerably more flexibility is provided in the nature of the display which can be provided and because the display is formed from a plurality of strands in spaced apart relationship, the configuration of the display can be a flat panel type display, a cylindrical display, a three dimensional display or a display of other geometric configurations.

In one embodiment each strand contains a plurality of nodes and the output of each fibre is located at a respective node.

In one embodiment the output includes the output end of the waveguide.

In one embodiment each waveguide includes an optical fibre.

In one embodiment each node includes a diffusing acrylic bead.

In one embodiment the bead is of cylindrical shape.

In one embodiment each strand is formed from an opaque sheath on which the nodes of that strand are supported, and the waveguides being supported in the sheath.

In one embodiment each fibre passes through the sheath and has an output end embedded in a respective node.

In an embodiment, the strands are oriented vertically in use.

In an embodiment, subsets of the plurality of strands are arranged in a plurality of substantially parallel planes.

In an embodiment, the optical display includes a controller for controlling the light driver.

In an embodiment, the optical display further includes an image source connected to the light driver such that the light driver drives the optical display to output at least one image output by the image source.

In an embodiment, the image source is a video source.

In an embodiment, the controller includes the image source.

In an embodiment, the light driver includes a projector.

In an embodiment, the optical display includes a plurality of light drivers for driving light to respective ones of the plurality of sub-sets of strands.

The invention also provides an optical display including:
a plurality of spaced apart strands, each strand including;
a support element for supporting a plurality of optical fibres;
a plurality of diffuser elements on the support element, the diffusers being spaced apart along the length of the strand;
a plurality of optical fibres supported by the support element, each of the plurality of optical fibres having a terminating end located at a respective diffuser element of the strand, and
wherein when light is provided to the optical fibres and propagates along the optical fibres, the light exits the terminating end of the fibres at the respective diffuser elements to thereby create an optical display.

In one embodiment the support element includes a hollow sheath, and the diffuser includes a cylindrical bead, each fibre passing through the hollow sheath and into a respective bead.

In one embodiment the beads are cylindrical beads.

In one embodiment the fibres have input ends which are supported in an array which corresponds to an array formed by the diffuser elements.

In one embodiment the input ends are supported in the array by a fibre catchment and a fibre optical harness extends between the catchment and the strands for supporting the optical fibres between the catchment and the strands.

In an embodiment, subsets of the strands are arranged in a plurality of substantially parallel planes.

In an embodiment, the input ends are supported in a plurality of arrays corresponding to respective ones of the planes.

### BRIEF DESCRIPTION OF THE DRAWINGS

Embodiments of the invention will now be described by way of example, with reference to the accompanying drawings in which:

FIG. 1 is a diagram of an optical display according to one embodiment of the invention;

FIG. 2 is a view of a strand used in the embodiment of FIG. 1;

FIG. 3 is a detailed view of part of the strand of FIG. 2;

FIG. 4 is a view of a display according to one embodiment of the invention in use;

FIG. 5 is a view of the display of FIG. 4 providing a different light display; and

FIG. 6 is a view of a second embodiment of the invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE EMBODIMENTS

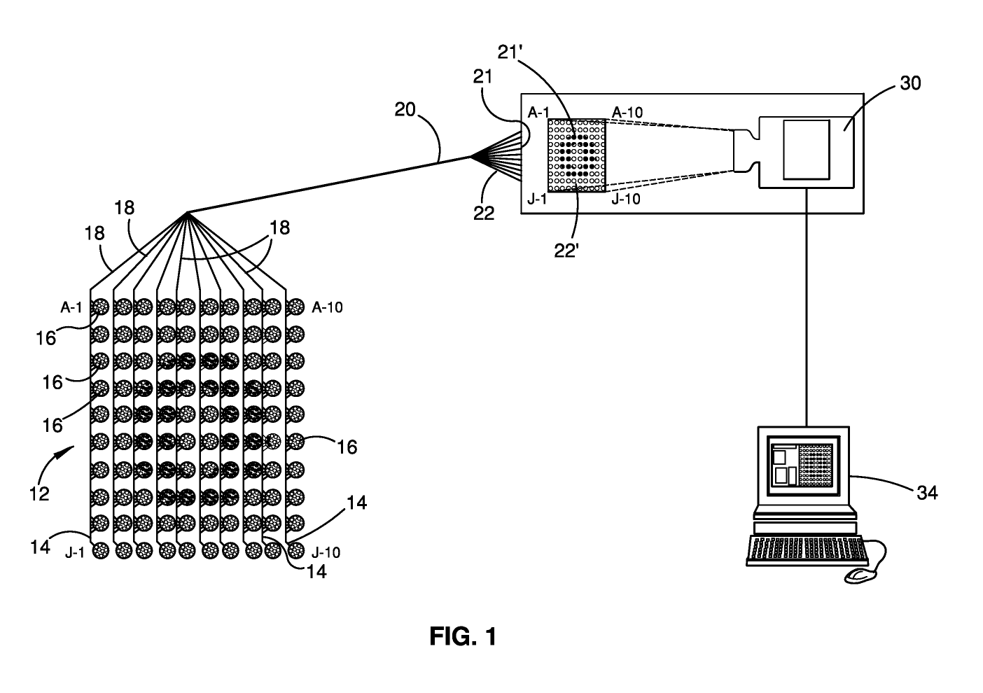

With reference to FIG. 1, a diagram illustrating one embodiment of the invention is shown. The optical display according to this embodiment includes a curtain 12 formed by a plurality of strands 14. In FIG. 1, ten strands are shown. However, typically in an actual working embodiment, many more strands will be provided.

Each strand 14 has a plurality of nodes 16 in the form of diffusers. In the embodiment shown, each strand 14 has ten such nodes but once again, in a working embodiment, more nodes may be provided. The nodes 16 form a rectangular grid A1 to J10 as shown in FIG. 1. Furthermore, not all of the strands 14 need be of the same length or have the same number of nodes 16.

As will be described in more detail hereinafter, each strand 16 has a plurality of optical fibres 18. The optical fibres 18 of one particular strand each have ends which terminate at one of the nodes 16 as will be described in more details hereinafter.

All of the optical fibres 18 are supported in an optical fibre harness 20 and have input ends 21 which are supported in a catchment 22 (which also is shown from the front and marked 22′ in FIG. 1 for ease of illustration) so that the ends of the fibres are supported in a grid pattern which corresponds to the array of nodes 16. The catchment 22 may have lenses (not shown) for directing the light into the input ends 21.

The fibre catchment 21 may be located at a remote location such as in a projector room or other control facility or located nearby for example concealed in a ceiling cavity. A projector 30 is provided for projecting light to the fibre catchment 22 so that light is received by each of the input ends of the fibres 18 so the light propagates along the fibres to the terminal output ends of the fibres at each of the nodes 16.

The projector 30 may be controlled by a controller 34 in the form of a computer, PC or the like to provide a static output image or a moving image, for example by generating an image with the computer and outputting via a port compatible with the projector in a conventional manner. Accordingly, the image source (e.g. controller 34) in conjunction with the optical display device provides an optical display system.

Therefore, light which is captured by the input ends of each of the fibres 18 is conveyed by the fibres 18 to the nodes 16 so as to reproduce the pattern or image which is projected onto the fibre catchment 22.

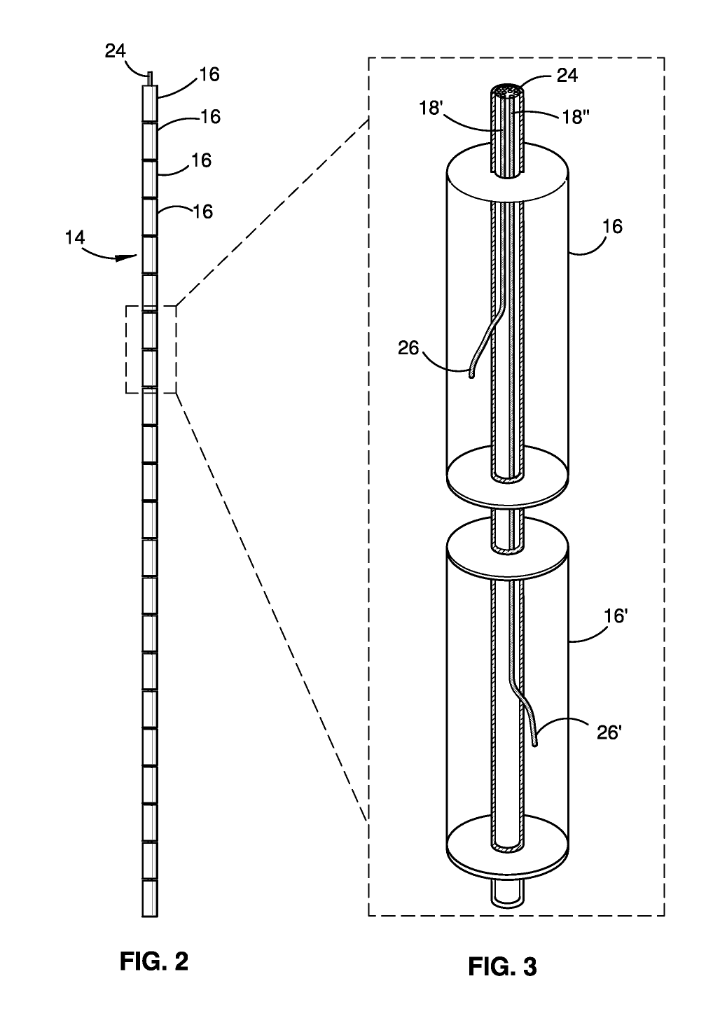

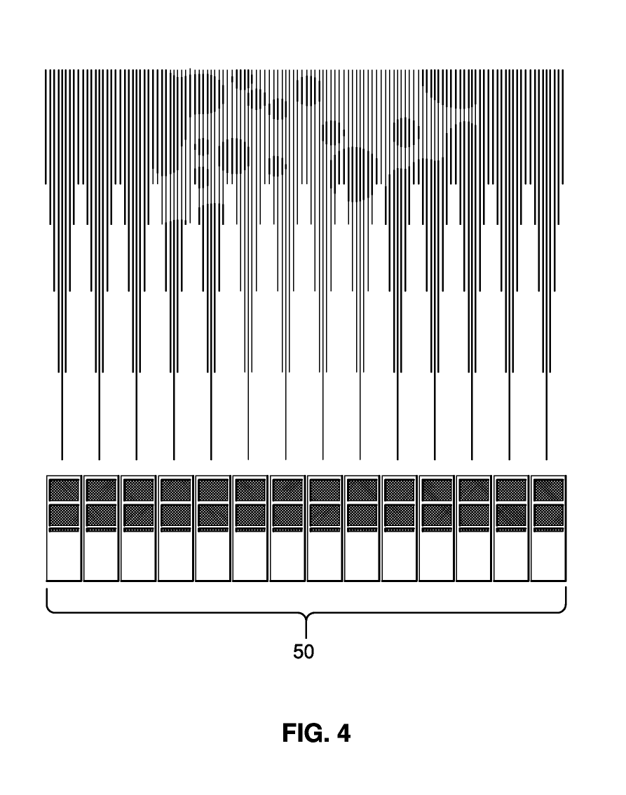

FIGS. 2 and 3 show the strands in more detail. As can be seen from FIG. 2, the strand 14 has nodes in the form of acrylic diffusers 16 which are slightly spaced from one another along the strand 14. The diffusers 16 are supported on a hollow sheath 24 and the fibres 18 of each strand are supported in the sheath 24 as is best shown in FIG. 3.

As is also shown in FIG. 3 which shows in detail part of the strand, one fibre labelled 18′ in FIG. 1 passes through the sheath 24 and has a terminating end 26 which is embedded in the acrylic diffuser 16 coupled to the diffuser by an optical connector (not shown). Another optical fibre 18″ is supported in sheath 24 and passes through the sheath 24. Terminal end 26′ is embedded in diffuser labelled 16′ in FIG. 3.

In the embodiment of FIG. 2, twenty two diffusers are shown and typically, twenty two fibres would therefore be supported in the sheath 24 and pass through the sheath and be embedded in one of the respective diffusers 16. Whilst in the embodiment shown, one fibre is associated with each of the diffusers 16, in other embodiments, a number of fibres could be associated with each diffuser 16.

The sheath 24 is opaque and each of the respective fibres 18 may provide light of a different colour by the use of filters (not shown) at the catchment 21 to supplement the colouring provided by the image projected by the projector 30.

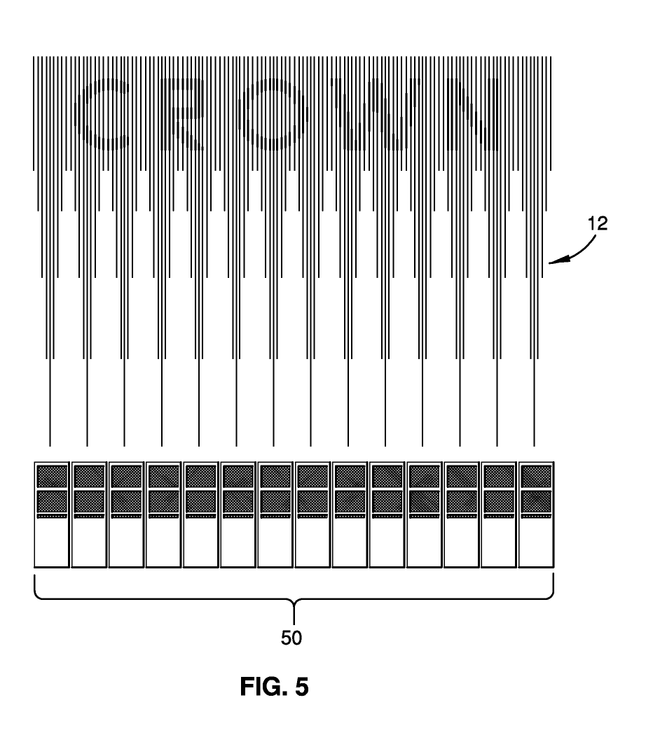

FIG. 4 shows an embodiment of the invention in which the curtain 12 is formed from strands having different lengths to form a strand pattern. Typically the curtain is hung vertically from a suitable support and the embodiment shown in FIG. 4 is arranged above a bank of gaming machines 50 to provide an attractive display above the gaming machines and to attract a person's attention to the gaming machines 50.

FIG. 5 shows the same curtain 12 as in FIG. 4 excepting the display provided by the curtain has changed to show the name of the establishment in which the gaming machines 50 are provided, or the nature or type of gaming machines below the curtain 12.

In the embodiments of FIGS. 4 and 5 the curtain 12 is in the form a generally planar curtain. In other embodiments, the curtain could be a cylindrical curtain, or a curtain of some other geometric shape.

The strands 16 of the curtain may be fixed so that they cannot move relative to one another and may be allowed to move freely relative to one another to further enhance the nature of the visual display.

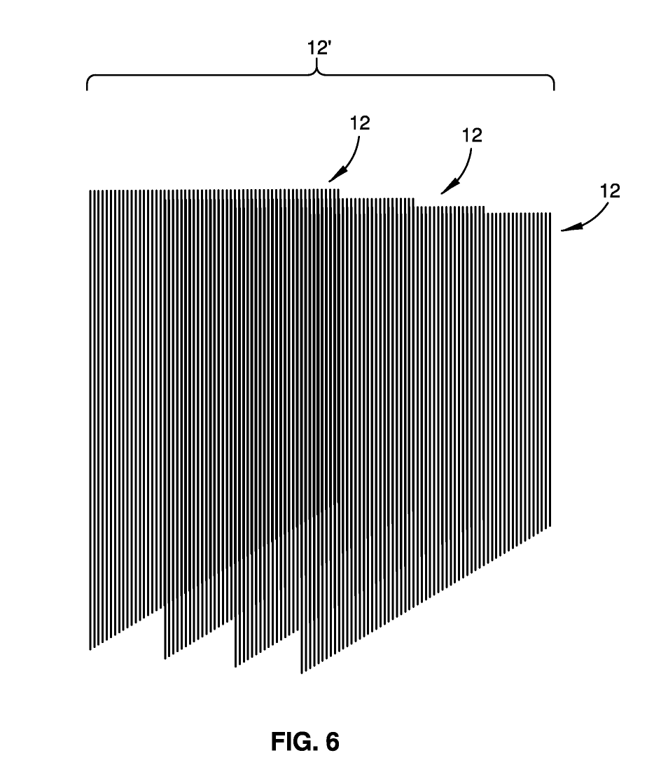

In FIG. 6, a display 12′ is shown which is formed from a number of planar curtains of the type previously described which are provided one in front of the other to thereby form a three dimensional display by the light which illuminates from each of the separate curtains 12 in FIG. 6. Thus, each curtain may have its own projector and controller for controlling the nature of the image projected to the curtain to thereby form the three dimensional display.

Thus, by projecting an image onto the catchment 21, the same image can be reproduced at the corresponding diffusers 16 within the curtain 12. Various different types of image projectors can be used to provide the image projected onto the catchment 21. Typically, the projectors may be an LCD project, a CRT projector, a DLP projector, an LCOS projector etc. Video projectors may be used which take video signals and project corresponding moving images onto the fibre catchment to provide a moving display. In this latest embodiment, the video projector receives the video source from the controller 34. As previously mentioned, the controller may be a computer, PC or may be a video source such as a DVD player, Blu-Ray player or the like. By utilising a controller, a new visual experience can be created to exhibit a variety of images, messages, graphics, logos and animation that can be delivered instantaneously.

An advantage of embodiments of the invention is the ability to provide moving imagery particularly in combination with a display which is attractive and unique in appearance.

In the embodiments, the strands are shown in a vertical arrangement, however it will be apparent that other orientations are possible as are more complicated arrangement, for example, the strands could be arranged to as to be curved.

Other modifications will be apparent to persons skilled in the art and in particular that features of the above embodiments can be combined to form further embodiments.

It is to be understood that, if any prior art publication is referred to herein, such reference does not constitute an admission that the publication forms a part of the common general knowledge in the art in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Method steps associated with certain embodiments may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

1. An optical display comprising:
a plurality of strands arranged in spaced apart relationship;
each strand having a plurality of waveguides with each guide having an output at a different position along the length of the respective strand;
each waveguide having an input end; and
a light driver supplying light to the input end of each waveguide so light can propagate along the waveguide and exit at the outputs.

2. The optical display of claim 1, wherein each strand contains a plurality of nodes and the output of each fibre is located at a respective node.

3. The optical display of claim 1, wherein the output comprises the output end of the waveguide.

4. The optical display of claim 1, wherein each waveguide comprises an optical fibre.

5. The optical display of claim 1, wherein each node comprises a diffusing acrylic bead.

6. The optical display of claim 5 wherein the bead is of cylindrical shape.

7. The optical display of any one of claim 1, wherein each strand is formed from an opaque sheath on which the nodes of that strand are supported, and the waveguides being supported in the sheath.

8. The optical display of claim 7, wherein each fibre passes through the sheath and has an output end embedded in a respective node.

9. The optical display of claim 1, wherein the strands are oriented vertically in use.

10. An optical display as claimed in claim 1, wherein subsets of the plurality of strands are arranged in a plurality of substantially parallel planes.

11. An optical display as claimed in claim 1 comprising a controller for controlling the light driver.

12. An optical display as claimed in claim 1, further comprising an image source connected to the light driver such that the light driver drives the optical display to output at least one image output by the image source.

13. An optical display as claimed in claim 12, wherein the image source is a video source.

14. An optical display as claimed in claim 12 when dependent on claim 11, wherein the controller comprises the image source.

15. An optical display system as claimed in claim 11, wherein the light driver comprises a projector.

16. An optical display as claimed in claim 10, comprising a plurality of light drivers for driving light to respective ones of the plurality of sub-sets of strands.

17. An optical display comprising:
a plurality of spaced apart strands, each strand comprising;
a support element for supporting a plurality of optical fibres;
a plurality of diffuser elements on the support element, the diffusers being spaced apart along the length of the strand; and
a plurality of optical fibres supported by the support element, each of the plurality of optical fibres having a terminating end located at a respective diffuser element of the strand,
wherein when light is provided to the optical fibres and propagates along the optical fibres, the light exits the terminating end of the fibres at the respective diffuser elements to thereby create an optical display.

18. The optical display of claim 17 wherein the support element comprises a hollow sheath, and the diffuser comprises a cylindrical bead, each fibre passing through the hollow sheath and into a respective bead.

19. The optical display of claim 18 wherein the beads are cylindrical beads.

20. The optical display of claim 17, wherein the fibres have input ends which are supported in an array which corresponds to an array formed by the diffuser elements.

21. The optical display of claim 20, wherein the input ends are supported in the array by a fibre catchment and a fibre optical harness extends between the catchment and the strands for supporting the optical fibres between the catchment and the strands.

22. The optical display of claim 17, wherein subsets of the strands are arranged in a plurality of substantially parallel planes.

23. The optical display as claimed in claim 22 wherein the fibres have input ends which are supported in an array which corresponds to an array formed by the diffuser elements, and wherein the input ends are supported in a plurality of arrays corresponding to respective ones of the planes.
